(19) United States
(12) Patent Application Publication
(10) Pub. No.: US 2007/0157954 A1
(43) Pub. Date: Jul. 12, 2007

(54) Dishwasher

(75) Inventors: Egbert Classen, Wertingen (DE); Bernd Mueller, Muggersturm (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate, GmbH, Munich (DE)

(21) Appl. No.: 10/581,652

(22) PCT Filed: Dec. 2, 2004
(86) PCT No.: PCT/EP04/53239

§ 371 Date: Feb. 16, 2007

(30) Foreign Application Priority Data
Dec. 4, 2003 (DE) 10356785.2

(51) Int. Cl. B08B 3/00

(52) U.S. Cl. 134/56 D; 134/105; 134/58 D

(57) ABSTRACT

A dishwasher is provided that allows washed dishes located in the washing container to be dried effectively and efficiently from an economic perspective so as to keep the energy consumption as low as possible in spite of a very good drying performance. The dishwasher includes a washing container, a device for washing items retained in the washing container using rinsing liquid, a medium-retaining container for retaining therein a vaporisable medium or a sublimable medium, and a sorber with reversibly dehydratable material.

The invention relates to a dishwasher comprising a washing container and devices for washing crockery using rinsing liquor. It is known that a dishwasher has a washing method whose program run consists of at least one partial program step “pre-rinse”, a “clean” section, at least one partial program step “intermediate rinse”, a partial program step “clear rinse” and a partial program step “dry”. The rinsing liquid is heated before or after a partial program step to enhance the cleaning effect. The rinsing liquid is usually heated using electrical heaters in the dishwashers and/or by supplying hot water from the domestic installation. Various drying systems are known for drying washed dishes in a dishwasher. For example, the washed dishes can be dried by own-heat drying if the rinsing liquid is heated in a partial program step “clear rinse” and thus the washed dishes which have undergone a hot clear rinse are dried by themselves by the material-dependent heat content of the washed dishes which has thus built up. In order to achieve this own-heat drying, the rinsing liquid is heated to a certain temperature by a separate heater in the “clear rinse” partial program step and applied to the washed dishes by means of spraying devices provided in the dishwasher. As a result of the relatively high temperature of the rinsing liquid in the “clear rinse” partial program step of usually 55° C. to 75° C., it is achieved that a sufficiently large quantity of heat is transferred to the washed dishes so that residual water adhering to said washed dishes vaporises as a result of the heat stored in the washed dishes. The vapour condenses on colder surfaces or is removed from the dishwasher by means of a fan. In a further known drying device, a separate heat source, e.g. a hot air fan, is used in the washing container to heat the moist air mixture during the drying process so that the air in the washing container can absorb a larger quantity of moisture. A disadvantage in the heating systems described above according to the prior art described is that the heating of the rinsing liquid is associated with a high energy requirement and the thermal energy required for each heating phase must be produced anew by means of electrical heating elements. The known heating systems also have the disadvantage that the heating of the rinsing liquid in the “clear rinse” partial program step and the processes in the “drying” partial program step are themselves associated with a high energy requirement and the thermal energy required is lost after the drying process because this escapes to the environment.

Dishwashers are known in which the moist air is vented outwards. This is disadvantageous since the surrounding kitchen furniture is damaged and the method requires a possibly unhygienic supply of air into the dishwasher from outside. Furthermore, dishwashers are known in which the moist air is passed over condensing surfaces on which the moisture condenses before being guided out. This condensation is either passed into the washing container or into special collecting containers. Known from DE 30 21 746 A1 is a method for operating a dishwasher wherein a heat exchanger connected to the washing container in a heat-conducting manner is supplied with cold fresh water during a partial program step “dry”. As a result, a condensation surfaces is produced on the inside of the washing container on which the moisture condenses and the condensation formed stays in the washing container. Since the temperature difference between the moist air and the fresh water which has been poured in is relatively small and the quantity of fresh water is continuously heated, the disadvantage arises that the condensation of the moist air takes a long time and the condensation performance is continuously reduced and the duration of the partial program step “dry” is long with a moderate drying result. With the duration of the drying process, the bacteria always present on the washed dishes are stimulated to rapid growth by the moist warm environment. It is thus the object of the present invention to provide a dishwasher which allows the washed dishes located in the washing container to be dried effectively and efficiently from an economic perspective so as to keep the energy consumption as low as possible in spite of a very good drying performance. This object is solved by the dishwasher according to the invention having the features according to claim 1. Advantageous further developments of the present invention are characterised in the dependent claims. The dishwasher according to the invention comprising a washing container and devices for washing dishes using rinsing liquid has a container with a vaporisable and/or sublimable medium and a sorber with reversibly dehydratable material wherein gas exchange can take place between container and sorber, and the sorber is used on the one hand directly for drying the dishes and on the other hand, the thermal energy used for desorbing the sorber is used to heat the rinsing liquor and/or the dishes located in the washing container. In a preferred embodiment, the container and the sorber are interconnected preferably closably by means of a valve by means of an exchange pipe for gas exchange. The connection between the container and the sorber can advantageously be specifically interrupted to control the absorption of medium by the sorber. Air is preferably guided by means of a fan through an outlet from the washing container into pipes and back into the washing container again through an inlet. In a further embodiment, first the container and then the sorber are arranged in the direction of flow of the air to the pipes to allow heat exchange between the flowing air into the pipes and the medium in the container as well as the reversibly dehydratable material in the sorber. In an additional embodiment, an electric heating element is located in the sorber for desorption of the reversibly dehydratable material. The electric heating element advantageously allows the specific desorption of the reversibly dehydratable material contained in the sorber through heating. Preferably, when the electric heating element is switched off and the valve is opened, the medium, e.g. water can be vaporised or sublimed in the container and the container with medium can be cooled by the latent heat of evaporation, the medium vapour is passed via the exchange pipe to the sorber and the medium vapour is absorbed by the reversible dehydratable material in the sorber whereby the sorber is heated with reversibly dehydratable material. Thus, the container is advantageously cooled and the sorber heated so that on the one hand moisture can be removed from the air by cooling and on the other hand, air can be heated to that the moisture absorption capacity of the air increases. In a further embodiment, when the electric heating element is switched on for desorbing the sorber, the sorber is heated and when the valve is opened, the medium bound in the sorber is evaporated, the medium vapour released in the sorber is passed to the container by means of the exchange pipe and the medium vapour is condensed in the container whereby the container with medium is heated as a result of the latent heat of evaporation. Thus, the medium absorbed in the sorber can advantageously be returned back into the container in the sense of closed cycle.

In an additional embodiment, during a “drying” partial program step air from the washing container is passed through the pipes and back into the washing container, wherein the air at the container is cooled and the moisture contained in the air is thereby at least partly condensed and the air at the sorber is heated to increase the moisture absorption capacity of the air. The air of the washing container circulated in the cycle is thus advantageously freed from moisture on the one hand and heated on the other hand so that dry and warm air can be fed into the washing container for drying the dishes.

Preferably during a partial program step using rinsing liquid to be heated, e.g. “clean” or “pre-rinse”, air from the washing container is passed through the pipes and back into the washing container again where the air at the container (12) is preferably heated and that at the sorber (10) is heated. This allows the thermal energy used for desorption to be used in a particularly advantageous manner for heating the rinsing liquor and/or the dishes.

More appropriately, the water formed at the container by condensation from the air flowing in the pipe is passed into the washing container or into a separate container. The condensation formed can thus be simply led off.

The invention is explained hereinafter with reference to the exemplary embodiment

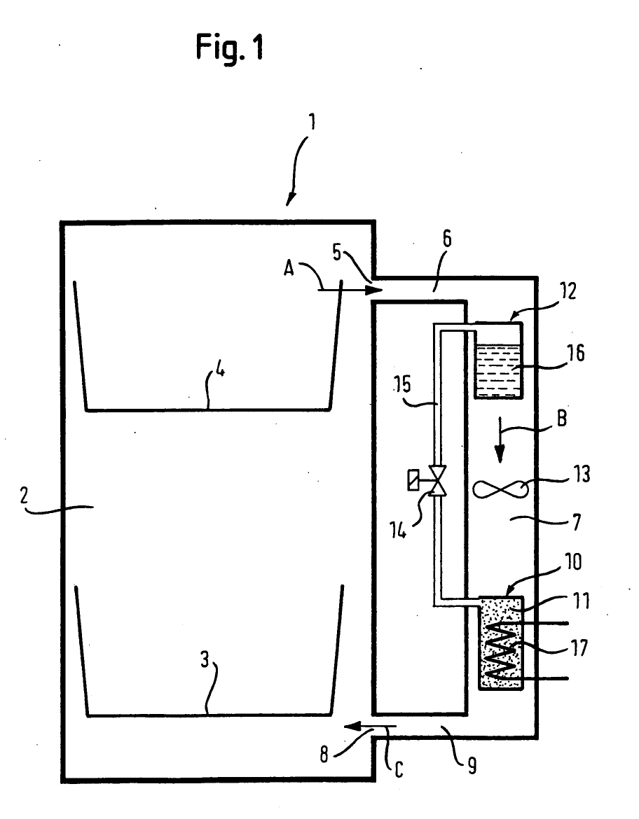

of a dishwasher according to the invention shown in FIG. 1. In the figures:

FIG. 1 is a schematic cross-section through a dishwasher according to the invention.

According to the invention, the dishwasher 1 has a closed air cycle which leads through the pipes 6, 7, 9 as well as the washing compartment 2 with crockery baskets 3, 4. The dishes are located in crockery baskets 3, 4 in the washing container 2. The dishes in the crockery baskets 3, 4 are not shown. Located in the upper area of the washing container 2 is an outlet 5 from the washing container 2 in which air flows into the pipe 6, see arrow A. Located in the lower area of the washing container 2 is an inlet 8 in which the air from the pipe 9 flows into the washing container 2, see arrow C. Located between the pipes 6 and 9 is the pipe 7 with the fan 13 which conveys the air in the pipe 7 in the direction of flow according to arrow B. Located at the end of the pipe 6 in the pipe 6 is a container 12 filled with water 16 or ice. Heat exchange between the air in the pipe 6 and the water 16 or ice in the container 12 is thereby possible. Located in the pipe 9 is the sorber 10 which contains reversibly dehydratable material 11, e.g. zeolite. An electric heating element 17 is provided in the sorber 10 which heats the reversibly dehydratable material 11 for desorption if necessary. The sorber 10 and the container 12 are interconnected by means of an exchange pipe 15, a valve 14 being disposed in the exchange pipe 15 in order to interrupt the connection between the container 12 and the sorber 10.

With the closed air system, exchange of contaminated air from the environment is eliminated, thus preventing any back-contamination of the treated items. It is known that a dishwasher has a washing method whose program run generally consists of at least one partial program step “pre-rinse”, a “clean” section, at least one partial program step “intermediate rinse”, a partial program step “clear rinse” and a partial program step “dry”. According to the invention, in a partial program step “dry” air from the washing container 2 is passed via the inlet 5 through the pipes 6, 7 and 9 and back via the inlet 8 into the washing container 2 with the aid of the fan 13. In the partial program step “dry” wet dishes to be dried with moist air are located in the washing container 2. The valve 14 in the exchange pipe 15 is preferably opened. The reversibly dehydratable material 11 contained in the sorber 10 has a relatively high capacity for moisture. If the container 12 is not connected to the sorption column 10 by opening the valve 14, the reversibly dehydratable material 11 absorbs a large quantity of the water 16 contained in the container 12 in a short time and the remainder of the water in the container 12 is severely cooled by latent heat of evaporation, e.g. until it freezes. The water 16 or ice in the container 12 evaporates or sublimes and the water vapour reaches the sorber 10 via the exchange pipe 15. In the sorber 10 the water vapour is absorbed by the reversibly dehydratable material 11. The reversibly dehydratable material 11 and therefore the sorber 10 is heated by the condensation heat produced. As a result of the cooling of the container 12, a very large temperature difference is produced between the moist air and the condensation surface formed on the inside of the pipe 6. The moist air passed out from the washing container condenses as a result. The released condensation must be led off, e.g. into the washing container 2 or into a separate storage container (not shown). The cooled air from which moisture has been removed at the container 12 is passed via the pipe 7 to the sorber 10. The sorber 10 has a severely elevated temperature, e.g. 90° as a result of the condensation heat produced. This results in heating of the air passed through the pipe 9 whereby the relative air moisture decreases further and the moisture absorption capacity of the air increases substantially. This dry and warm air is fed into the washing container 2 via the inlet 8 and can heat and dry the dishes to be dried here. The air fed in via the inlet 8 absorbs moisture in the washing compartment 2 and cools down and is then passed into the pipe 6 via the outlet 5 in a closed cycle. The valve 14 is preferably opened during the partial program step “dry” so that the cooling of the container 12, the heating of the sorber 10 and the circulation of the air through the pipes 6, 7 and 9 take place simultaneously. However, the valve 14 can already been opened before the beginning of air circulation so that at the beginning of circulation of the air for drying, the container 12 is correspondingly cooled and the sorber 10 is heated and thus the complete drying capacity is available from the beginning. Furthermore, the valve can also be at least partly closed during circulation of the air because no additional cooling or heating is required as a result of the heat and cold storage capacity of the container 12 and the sorber 10. During other part program steps which require no drying, the valve 14 normally remains closed because any unnecessary heating or cooling of the container 12 or sorber 10 would thereby be achieved. The reversibly dehydratable material 11 is the sorber 10 must be heated to very high temperatures for desorption, which is accomplished using the electric heating element 17. In this case, the stored liquid emerges as hot water vapour which reaches the container 12 via the exchange pipe 15 when the valve 14 is open, said container acting as a condenser because the hot water vapour condenses in the container 12. The container 12 and the water 16 is heated by the condensation heat. The sorber 10 is heated to high temperatures, e.g. 150°-200° by the electrical heating element. According to the invention, the thermal energy used for desorption is at least partly used for heating the rinsing liquor and/or the dishes in a partial program step using the rinsing liquor to be heated or already heated rinsing liquor, e.g. “clean” or “pre-rinse”. For this purpose, during the desorption of the sorber 10 the fan 13 is preferably switched on and the air from the washing container 2 is circulated through the pipes 6, 7 and 9 according to the arrows A, B and C. In this case, the air at the container 12 and especially at the sorber 10 is heated. The fan 13 is preferably only switched on when the temperature in the container 12 is higher than that in the washing container 2. It is also possible that during the desorption phase the air is guided around the container 12 by means of a bypass pipe (not shown) until the temperature in the container 12 is higher than that in the washing container 2. The heating of the air in the container 12 and especially in the sorber 10 is largely sufficient to adequately heat the rinsing liquor and/or the dishes. Thus, any further heating can be largely dispensed with and the energy used for desorption can be almost completely used for heating the rinsing liquor and/or the dishes apart from the small amount of energy required to overcome the binding forces between water and reversibly dehydratable material. Thus, any further heating can largely be dispensed with. In addition to the energy saving, efficient cleaning of the items for washing is also ensured. Advantageously, the washed dishes can thereby be effectively dried with a low heat content, e.g. plastic parts because no heating is required in the partial program step preceding the “dry” partial program step. The rapid drying also allows severely reduced bacteria growth or even completely prevents bacteria growth which advantageously affects the hygiene conditions on the cleaned dishes. The present invention provides a dishwasher which allows the washed dishes located in the washing container to be cleaned and dried effectively from an economic perspective and so keep the energy consumption as low as possible.

1-10. (canceled)

11. A dishwasher comprising:
a washing container;
a device for washing items retained in the washing container using rinsing liquid;
a medium-retaining container for retaining therein a medium that is at least one of a vaporisable medium and a sublimable medium, whereby the medium retained in the medium-retaining container can be subjected to at least one of an evaporation step and a sublimation step, whereby the medium is cooled; and
a sorber with reversibly dehydratable material, the sorber and the medium-retaining container being communicated with one another such that gas exchange can take place therebetween, the reversibly dehydratable material acting to absorb vapor that has flowed from the medium-retaining container into the sorber, wherepon the reversibly dehydratable material transforms from a dehydrated state into a hydrated state and the reversibly dehydratable material being restorable from a hydrated state into a dehydrated state by the application of thermal energy to the reversibly dehydratable material, the sorber being operable, on the one hand, to directly dry items retained in the washing container and being operable, on the other hand, to provide the thermal energy used for desorbing the sorber such that at least one of the rinsing liquor and the items located in the washing container are heated thereby.

12. The dishwasher according to claim 11, and further comprising an exchange pipe interconnecting the medium-retaining container and the sorber with one another such that gas exchange can take place therebetween, the exchange pipe having a valve for selectively permitting the flow of vapor through the exchange pipe.

13. The dishwasher according to claim 11, wherein the medium-retaining container is communicated via an outlet with the washing container, the sorber is communicated with the washing container via an inlet, and further comprising a fan for guiding air from the washing container to the medium-retaining container, whereupon the air is thereby cooled upon contact with the cooled medium in the medium-retaining container, and for subsequently guiding the cooled air into contact with the reversibly dehydratable material in the sorber, whereupon the air is heated, and for thereafter guiding such heated air back into the washing container through the inlet.

14. The dishwasher according to claim 11, wherein first the medium-retaining container and then the sorber are arranged in the direction of flow of the air from the washing container to allow heat exchange between the flowing air and the medium in the medium-retaining container as well as the reversibly dehydratable material in the sorber.

15. The dishwasher according to claim 12, and further comprising an electric heating element located in the sorber for desorption of the reversibly dehydratable material.

16. The dishwasher according to claim 15, wherein, when the electric heating element is switched off and the valve is opened, the medium can be vaporised or sublimed in the medium-retaining container and the medium-retaining container with medium can be cooled by the latent heat of evaporation, the medium vapour is passed via the exchange pipe to the sorber and the medium vapour is absorbed by the reversible dehydratable material in the sorber whereby the sorber is heated with reversibly dehydratable material.

17. The dishwasher according to claim 15, wherein, when the electric heating element is switched on for desorbing the sorber, the sorber is heated and, when the valve is opened, the medium bound in the sorber is evaporated, the medium vapour released in the sorber is passed to the medium-retaining container by means of the exchange pipe and the medium vapour is condensed in the medium-retaining container whereby the medium-retaining container with medium is heated as a result of the latent heat of evaporation.

18. The dishwasher according to claim 16, wherein the medium-retaining container is communicated via an outlet with the washing container, the sorber is communicated with the washing container via an inlet, and the medium-retaining container and the sorber are communicated with one another by an air guiding pipe such that air can be guided from the washing container to the medium-retaining container, whereupon the air is thereby cooled upon contact with the cooled medium in the medium-retaining container, the cooled air subsequently guided into contact with the reversibly dehydratable material in the sorber, whereupon the air is heated, and thereafter such heated air can be guided back into the washing container through the inlet, and, during a “drying” partial program step, air from the washing container is passed through the air guiding pipe and back into the washing container, wherein the air at the medium-retaining container is cooled and the moisture contained in the air is thereby at least partly condensed and the air at the sorber is heated to increase the moisture absorption capacity of the air.

19. The dishwasher according to claim 17, wherein the medium-retaining container is communicated via an outlet with the washing container, the sorber is communicated with the washing container via an inlet, and the medium-retaining container and the sorber are communicated with one another by an air guiding pipe such that air can be guided from the washing container to the medium-retaining container, whereupon the air is thereby cooled upon contact with the cooled medium in the medium-retaining container, the cooled air subsequently guided into contact with the reversibly dehydratable material in the sorber, whereupon the air is heated, and thereafter such heated air can be guided back into the washing container through the inlet, and, during a “drying” partial program step using rinsing liquid to be heated, e.g. “clean” or “pre-rinse”, air from the washing container is passed through the air guiding pipe and back into the washing container again where the air at the container is preferably heated and that at the sorber is heated.

20. The dishwasher according to claim 18 and further comprising means for flowing water formed at the medium-retaining container by condensation from the air flowing in the air guiding pipe into at least one of the washing container and a separate container.
